(19) United States
(12) Patent Application Publication
(10) Pub. No.: US 2015/0122581 A1
(43) Pub. Date: May 7, 2015

(54) FOLDING UTILITY RAMP WITH STEPS

(71) Applicant: Steven I. Mahre, Yakima, WA (US)

(72) Inventor: Steven I. Mahre, Yakima, WA (US)

(21) Appl. No.: 14/074,525

(22) Filed: Nov. 7, 2013

(51) Int. Cl. B60R 3/00; B65G 69/30

(52) U.S. Cl. CPC B60R 3/007; B65G 69/30
USPC 182/129

(57) ABSTRACT

A portable utility ramp that folds onto a collapsible set of steps, allowing a user to walk an in-line two-wheeled vehicle, such as a motorcycle, up or down the ramp. The inclined ramp is positionable between a ground surface and the receiving bed of a truck or trailer, with the ramp hingably attached to a set of steps each positioned parallel to the ramp, and the ramp foldable over and onto the se of steps by action of hinges between the steps and the ramp. The set of steps includes a multiple of treads mounted within a step frame that pivots in a scissor-like action either above or beneath the main frame. The ramp and step's parallel configuration allows the user to guide the motorcycle up the ramp, while walking up the set of steps that remain parallel to the ground, no matter the incline of the ramp.

### TECHNICAL FIELD

The invention relates to an improved portable ramp system with steps. More specifically, the invention pertains to a two-part utility ramp, with a ramp that can fold onto a collapsible set of steps, allowing a user to walk a two-wheeled vehicle up or down the ramp.

### BACKGROUND OF TILE INVENTION

Conventional truck and vehicle utility ramps include an inclined plane to provide a means for loading and unloading motorcycles and the like, into and out of the bed or cargo area of the vehicle. These conventional ramps included a wide variety of features, some able to adjust to various vehicle configurations, and others with folding features to aid in storage, when not in use.

Several difficulties arise in prior configurations and designs of utility ramps, especially when addressing motorcycle loading and unloading. Motorcycles can be heavy to move, and difficult to direct p and down loading ramps. Additionally, many truck beds are very high off the ground, especially when the truck is equipped with a four-wheel drive suspension. With these high truck beds carrying heavy bikes, a ramp system is needed that gives the user the ability to better guide the motorcycle up and down the ramp. A utility ramp is needed that is well suited for motorcycle loading and unloading in and out of truck beds. Additionally, a utility ramp is needed that provides the user with stable access to the motorcycle up and down the ramp, while also providing compact storage features.

The following is a disclosure of the present invention to meet these needs, which will be described and understood by reference to the following detailed description taken in conjunction with the accompanying drawings.

### BRIEF DESCRIPTION OF DRAWINGS

FIG. 1A is a side view of a folding ramp with steps, shown deployed on o a vehicle, according to an embodiment of the invention;

FIG. 1B is a side view of a folding ramp with steps, shown deployed onto a vehicle, according to an alternative embodiment of the invention;

FIG. 2 is a rear view of a folding ramp with steps, shown deployed onto a vehicle, according to the embodiment of the invention as shown in FIG. 1A;

FIG. 3 is a perspective view of a folding ramp with steps, shown with a motorcycle and user, according to an embodiment of the invention;

FIG. 4 is a perspective view of a folding ramp with steps, in a fully deployed configuration, according to an embodiment of the invention;

FIG. 5 is a perspective view of a folding ramp with steps, in a partially collapsed configuration, according to an embodiment of the invention; and

FIG. 6 is a perspective view of a folding ramp with steps, in a fully folded configuration, according to an embodiment of the invention.

Reference characters included in the above drawings indicate corresponding parts throughout the several views, as discussed herein. The description herein illustrates one preferred embodiment of the invention, in one form, and the description herein is not to be construed as limiting the scope of the invention in any manner. It should be understood that the above listed figures are not necessarily to scale and that the embodiments are sometimes illustrated by fragmentary views, graphic symbols, diagrammatic or schematic representations, and phantom lines. Details that are not necessary for an understanding of the present invention by one skilled in the technology of the invention, or render other details difficult to perceive, may have been omitted.

### DETAILED DESCRIPTION OF SPECIFIC EMBODIMENTS

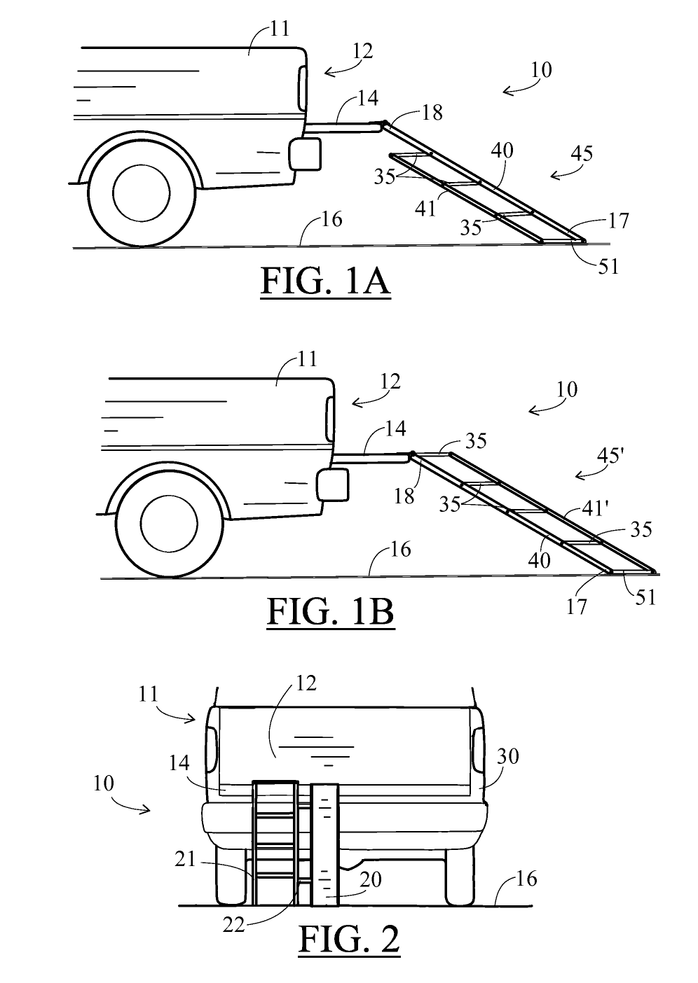

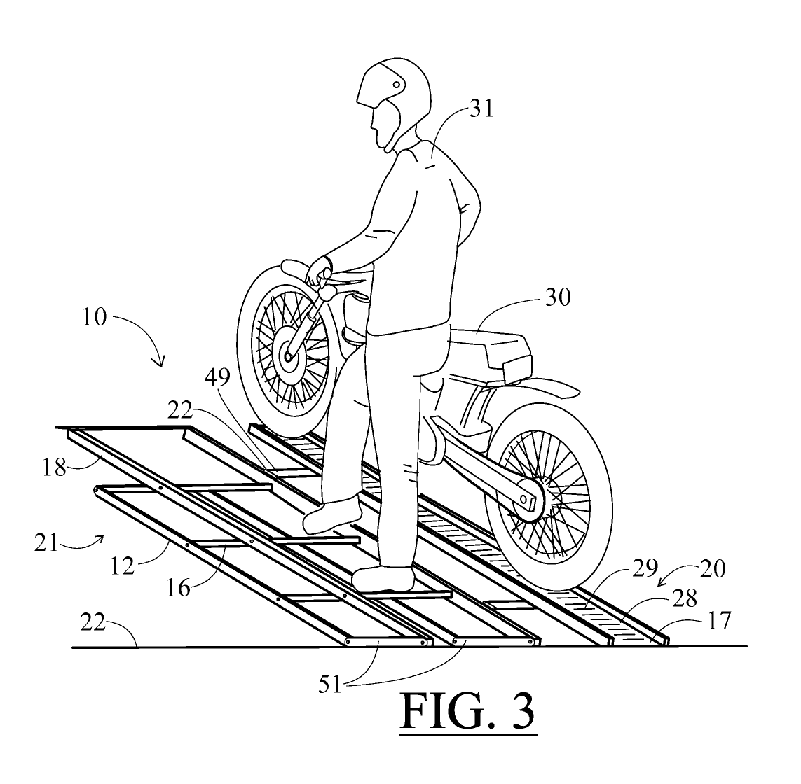

The present invention provides a folding ramp and step system, which includes an inclined ramp hingably coupled to a parallel set of folding steps. FIGS. 1A through 6 show preferred embodiments of the folding ramp and step system 10 having features according the present invention. FIGS. 1A, 1B and 2 illustrate the folding ramp and step system as mounted to a conventional truck 11, in a preferred use of the folding ramp and step system. For the present description, the folding ramp and step system may be referred to simply as the ‘ramp system,’ or the ‘utility ramp system’ and the conventional truck, which may be referred to simply as a ‘truck,’ includes a cargo bed 12 typically referred to as a ‘bed’, which is accessible by lowering a tailgate 14. Additionally, the truck may be any vehicle or trailer with a receiving bed or bay, Alternatively, the ramp system can be employed to serve a stationary loading bay, and also may be used to bridge up and over a raised abutment or an embankment.

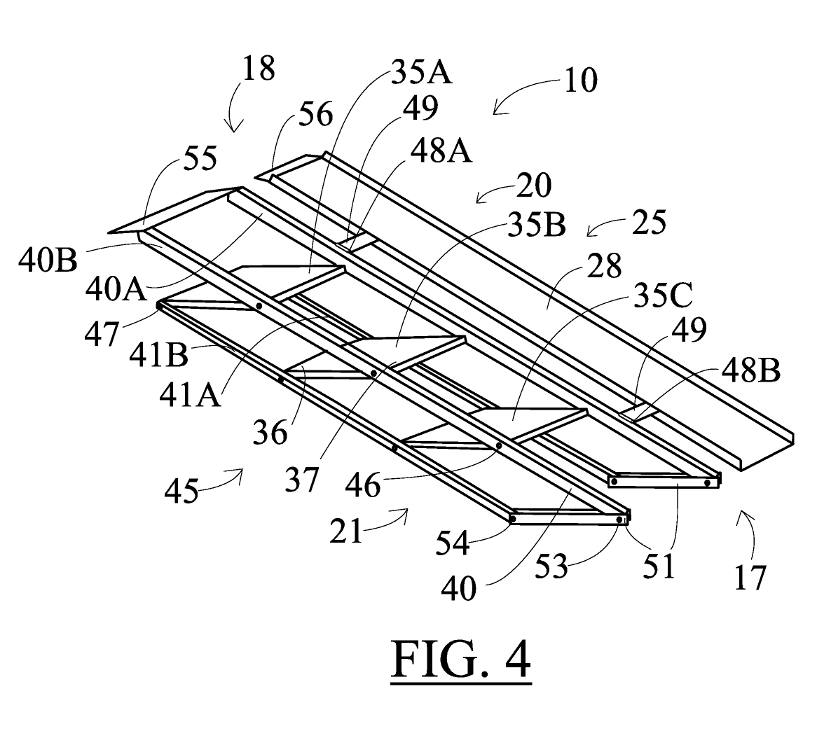

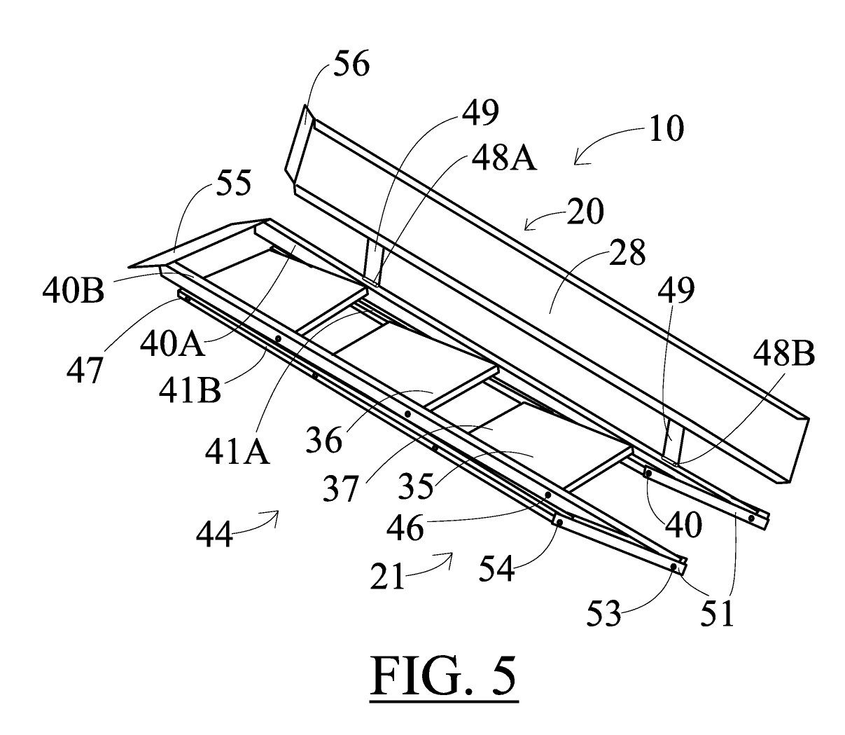

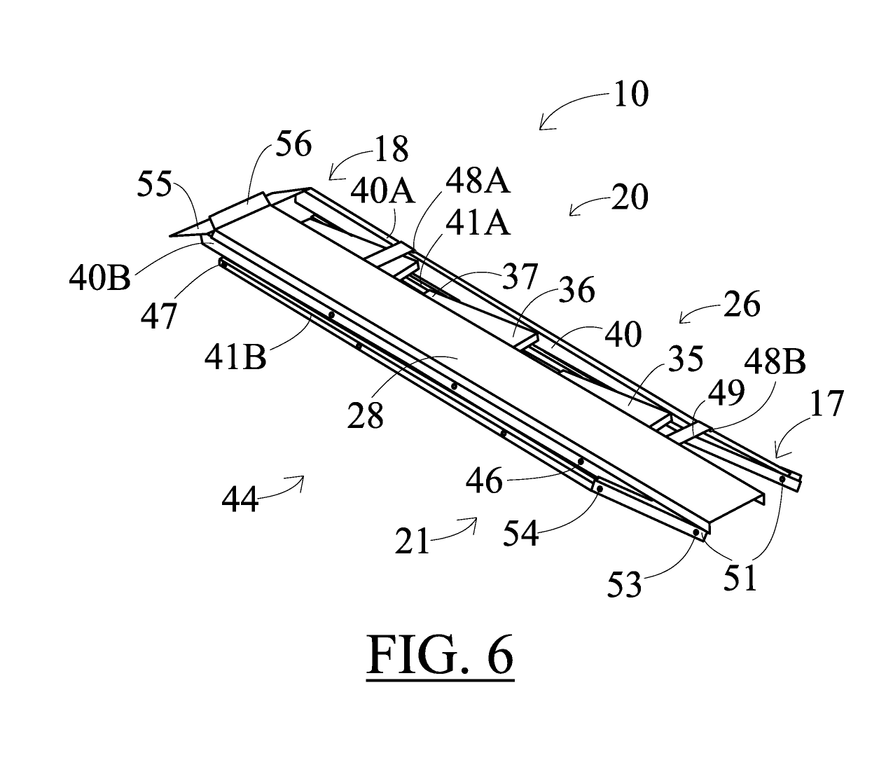

Specifically, as shown in FIGS. 1A and 1B, when installed on the truck as preferred, the ramp system 10 of the present invention bridges between aground surface 16 at a bottom end 17 of the ramp system, and the cargo bed 12 of the truck 11 at a top end 18 of the ramp system. As shown in FIG. 2, the ramp system includes a ramp element 20, attached to a step element 21 at a hingable connection 22. FIG. 5 shows the ramp element swinging about the hingable connection from a deployed ramp position 25 shown in FIG. 4, to a folded ramp position 26 shown in FIG. 6. The ramp element hingably unfolds on the hingable connection o the step element to form an inclined bridge from the ground surface to the bed, as shown in FIGS. 1A, 1B and 2.

The ramp element 20 includes a generally planar elongated member 28, or simply referred. to herein as the “ramp,” which is preferably channeled along is length, as shown in FIG. 3, to best receive and guide a motorcycle 30. Additionally, the ramp of the ramp element can include traction treads 29 to provide better traction for the motorcycle or any other in-line two-wheeled vehicle, similarly configured to a motorcycle, such as a bicycle, which a user 31 may wish to guide up the ramp element. Additionally or in the alternative, the ramp can include holes or perforations to act as treads, to allow water to run through rather than down the ramp element, and to reduce the weight of the ramp element.

The step element 21 is approximately parallel to the ramp element 20, and is similarly inclined between the ground surface 16 and the cargo bed 12 of the truck 11, as shown in FIG. 1A. The step element has a set of steps 33 including a multiple of treads 35, with each tread including a forward end 36 and a rearward end 37. As shown in the preferred embodiment of FIG. 1A, the forward end of each tread is pivotably mounted to a main frame 40, and the rearward end of each tread is pivotably mounted to a step frame 41.

As shown in FIG. 1A, the main frame 40 is a part of the step element 21 and is positionable to span between the ground surface 16 and the receiving bed 12 of the truck 11 or trailer. Most preferably, the main frame includes an inner main rail 40A and an outer main rail 40B, as detailed in FIG. 4.

The step frame 41 pivots downward, in a scissor-like action beneath the main frame 40. The step frame pivots from the retracted step position 44 shown in FIG. 5, to a deployed step position 45 as shown in FIG. 1A. FIGS. 2, 3 and 4 also illustrate the deployed step position, with each of the multiple of treads 35 of the set of steps 33 of the step element positioned approximately parallel to the ground surface 16.

The terms “approximately” or “approximate” are employed herein throughout, including this detailed description and the attached claims, with the understanding that is denotes a level of exactitude commensurate with the skill and precision typical for the particular field of endeavor, as applicable.

Alternatively, instead of the step frame 41 hinging below the main frame 40, the step frame can be mounted above the main frame to become a raised step frame 41′ with the forward end of each of the multiple of tread 35 pivotably mounted to the raised frame, and the rearward end of each tread pivotably mounted to the main frame 40, With this alternate configuration, the main frame is still positionable to span between the ground surface 16 and the receiving bed 12 of the truck 11 or trailer, but instead of deploying downward, the raised step frame pivots to deploy upward, in a scissor-like action above the main frame 40. Instead of pivoting downward to the deployed step position 45 as preferred, in this alternative embodiment of the invention, the raised step frame pivots upward from the retracted step position to a raised deployed step position 45′, as shown in FIG. 1B. Most preferably, for the embodiment with the raised deployed step position, the tread at the top end 18 of the ramp element 20 is approximately level with the tail-gate 14 of the truck 11.

The unique, parallel configuration of the ramp element 20 to the step element 21, as shown in FIG. 2, allows the user 31 to guide the in-line two-wheeled vehicle or motorcycle 30 up the ramp element, while walking up the set of steps 33, as shown in FIG. 3. Regardless of the height of the bed 12 or tailgate 14 of the truck 11, each of the multiple of treads 35 in the set of steps remain parallel to the ground surface 16, no matter the incline of the ramp system 10.

As shown in FIGS. 1A, 2, 3, 4, 5 and 6, for a preferred embodiment of the ramp system 10, the set of steps 33 in the step element 21 has three treads for the multiple of treads 35. Specifically, as shown in FIGS. 4 through 6, the forward end 36 of each tread pivotably mounts to the main frame 40 at a forward tread pivot 46, and the rearward end 37 of each tread pivotably mounts to the step frame 41 at a rearward tread pivot 47. Most preferably, the step frame includes an inner step rail 41A and an outer step rail 41B, as shown in FIG. 4. The forward and rearward pivots operate in pairs, on each side of the step element.

The ramp system 10 can include any number of step treads for the set of steps 33 in the step element 21. As shown in FIG. 4, in a preferred embodiment of the ramp system, the multiple of treads 35 include a middle tread 35B, positioned between a lower tread 35C and an upper tread 35A. The number of treads in the multiple of treads can be selected by any number of factors, including the height of the cargo bed 12 off the ground surface 16, the preference of the user 31, the steepness of the step element, and the desired distance from the forward end 36 to the rearward end 37 of the individual treads.

Preferably, the ramp element 20 hingably mounts to the main frame 40 of the step element 21, with the ramp element foldable over and onto the step element. This folding is by the action of the hingable connection 22, which is preferably embodied by a plurality of hinges 48 between the set of steps 33 and the ramp 28. Most preferably, two hinges comprise the plurality of hinges, with an upper hinge 48A and a lower hinge 48B, connecting the step element to the ramp element, as shown in FIGS. 4 through 6. Alternatively, a single or any multiple of hinges could be employed for the plurality of hinges, including a single, long ‘piano’ style of hinge, positioned along a portion of the main frame of the step element, for instance. Most preferably, each hinge of the hingable connection is mounted on the main frame of the step element, and additionally includes an extension tab 49, which connects the hinge to the ramp element, as shown in FIGS. 3 through 6,

In the alternative embodiment of the ramp system 10 with the upward deployed step position as shown in FIG. 1B, the extension tab 49 preferably includes an offset (not shown) to accommodate the raised step frame, when retracted.

In the preferred embodiment of the ramp system 10 as shown in FIG. 3, a pair of bottom bars 1 are preferably employed at the bottom end 17 of the ramp system. The pair of bottom bars are used in the place of an additional tread in the multiple of treads 35 for the set of steps, and serve to rest on the ground surface 16 when the step element 21 is in the deployed step position 45. The pair of bottom bars pivot along the set of steps and each of the pair of bottom bars connect the main frame 40 to the step frame 41 of the step element. The pair of bottom bars pivot on the main frame at a forward bar pivot 53, and pivot on the step frame at a rearward bar pivot 54. When moved from the deployed step position as shown in FIG. 4, to the retracted step position, as shown in FIG. 5, the pair of bottom bars match the movements of the multiple of treads and collapse upward to a position approximately parallel with the main frame 40, and approximately in line with the step frame, as shown in FIGS. 5 and 6.

Preferably, to best seat upon the tailgate 14 of the bed 12, caps are mounted proximate to the top end 18 of the ramp system 10. Most preferably, a top step cap 55 is mounted across inner main rail 40A to the outer main rail 40B of the step element 21, proximate to the to top end of the ramp system. Additionally, a top ramp cap 56 is mounted on the ramp 28, proximate to the to top end of the ramp system, on the ramp element as shown in FIGS. 4 and 6.

As shown in FIG. 6, with the ramp element 20 hinged over and onto the step element 21 into the folded ramp position 26, and the step frame 41 with the multiple of treads 35 of the step element retracted upward and flush beneath the main frame 40 in the retracted step position 44, the ramp system 10 is very compact and much easier to move and store. With an appropriate selection of lightweight and strong materials, the ramp system can be handled by one person, both in deploying for use and in folding for removal and storage.

A most preferred material for the ramp system 10 is an aircraft quality aluminum alloy, with steel hinges and pivot parts, as would be well known to persons skilled in the manufacture of lightweight structural components employing hinges and pivots. However, alternate materials could. be employed with the ramp system. For instance, steel alloys, carbon fiber, wood and fiberglass could all be used for particular components or possibly in the entirety for construction of the ramp system again as selectable by a person skilled in the selection and construction of light weight, load-bearing devices.

In compliance with the statutes, the invention has been described in language more or less specific as to structural features and process steps. While this invention is susceptible to embodiments in different forms, the specification illustrates preferred embodiments of the invention with the understanding that the present disclosure is to be considered an exemplification of the principles of the invention, and the disclosure is not intended to limit the invention to the particular embodiments described. Those with ordinary skill in the art will appreciate that other embodiments and variations of the invention are possible, which employ the same inventive concepts as described above. Therefore, the invention is not to be limited except by the following claims, as appropriately interpreted in accordance with the doctrine of equivalents.

The following is claimed:

1. A utility ramp system comprising:
a ramp element including a generally planar elongated member, the ramp element position-able between a surface and a receiving bed;
a step element including a main frame positioned above a step frame, and a set of steps connecting the main frame to the step frame, the set of steps having a multiple of treads, with each tread of the multiple of treads including a forward end and a rearward end, the forward end of each of the multiple of treads pivotably mounted to the main frame, and the rearward end of each of the multiple of treads pivotably mounted to the step frame;
the ramp element hingably mounted in parallel to the main frame of the step element at a hingable connection, the ramp element foldable over and onto the step element by action of the hingable connection; and
The step frame of the step element retractable upward and approximately flush beneath the main frame of the step element.

2. The utility ramp system according to claim 1, additionally wherein:
the main frame of the step element is positionable between a ground surface and a receiving bed, and the step frame of the step element pivots downward in a scissor-like action beneath the main frame, to position each of the multiple of treads approximately parallel to the ground surface.

3. The utility ramp system according to claim 1, additionally wherein:
the ramp element receives and transfers an in-line two-wheeled vehicle, the in-line two-wheeled vehicle guidable up the generally planar elongated member of the ramp element by a user standing upon the step element.

4. The utility ramp system according to claim 3, additionally wherein:
the set of steps pivot in a parallel action to allow the user to guide the in-line two-wheeled vehicle up the ramp, while walking up the set of steps, and the multiple of tread of the set of steps remain parallel to the ground surface, independent of the incline of the ramp element.

5. A utility ramp system comprising:
a ramp element including a generally planar elongated member, the ramp element position-able between a surface and a receiving bed;
a step element including a main frame positioned below a step frame, and a set of steps connecting the main frame to the step frame, the set of steps having a multiple of treads, with each tread of the multiple of treads including a forward end and a rearward end, the forward end of each of the multiple of treads pivotably mounted to the step frame, and the rearward end of each of the multiple of treads pivotably mounted to the main frame;
the step frame of the step element retractable downward and approximately flush upon the main frame of the step element; and
the ramp element hingably mounted in parallel to the main frame of the step element at a hingable connection, the ramp element foldable over and onto the step element by action of the hingable connection.

6. The utility ramp system according to claim 5, additionally wherein:
the main frame of the step element is positionable between a ground surface and a receiving bed, and the step frame of the step element pivots upward in a scissor-like action above the main frame, to position each of the multiple of treads approximately parallel to the ground surface.

7. The utility ramp system according to claim 5, additionally wherein:
the ramp element receives and transfers an in-line two-wheeled vehicle, the in-line two-wheeled vehicle guidable up the generally planar elongated member of the ramp element by a user standing upon the step element.

8. The utility ramp system according to claim 7, additionally wherein:
the set of steps pivot in a parallel action to allow the user to guide the in-line two-wheeled vehicle up the ramp, while walking up the set of steps, and the multiple of tread of the set of steps remain parallel to the ground surface, independent of the incline of the ramp element.
